(19) United States
(12) Patent Application Publication
(10) Pub. No.: US 2016/0268649 A1
(43) Pub. Date: Sep. 15, 2016

(54) BATTERY PACK

(71) Applicant: Samsung SDI Co., LTD., Yongin-si (KR)

(72) Inventors: Sangdo Heo, Yongin-si (KR); Bongkoun Jang, Yongin-si (KR); Jonghwa Hur, Yongin-si (KR); Chanwoo Kang, Yongin-si (KR)

(21) Appl. No.: 14/838,704

(22) Filed: Aug. 28, 2015

(30) Foreign Application Priority Data
Mar. 11, 2015 (KR) 10-2015-0033791

(51) Int. Cl. H01M 10/46; H02J 7/00

(52) U.S. Cl. CPC H01M 10/46; H02J 7/007

(57) ABSTRACT

A battery pack is disclosed. In one aspect, the battery pack includes a secondary battery including at least a pair of electrode tabs and a circuit board accommodating at least one circuit configured to control charging and/or discharging operations of the secondary battery. The circuit board includes a bending portion and first and second portions respectively extending from opposing ends of the bending portion and at least partially overlapping and spaced apart from each other. The first portion includes a tab fixing surface configured to fix the at least pair of electrode tabs thereto, and the second portion includes a circuit fixing surface configured to fix the at least one circuit thereto. The tab fixing surface faces the second portion. The battery pack also includes an insulating plate placed between the tab fixing surface and the second portion, and contacts the at least pair of electrode tabs.

### INCORPORATION BY REFERENCE TO ANY PRIORITY APPLICATIONS

This application claims priority to and the benefit of Korean Patent Application No. 10-2015-0033791, filed on Mar. 11, 2015, in the Korean Intellectual Property Office, the entire content of which is incorporated herein by reference in its entirety.

This application relates to U.S. patent application entitled “BATTERY PACK” (Attorney docket: SDISHN.351AUS, application Ser. No. ______), which is concurrently filed on the same date as this application and incorporated herein by reference in their entirety.

### BACKGROUND

1. Field

The described technology generally relates to a battery pack.

2. Description of the Related Technology

A secondary battery (or rechargeable battery) can be repeatedly used as it can be charged and discharged multiple times. The charging source can be via conventional power such as a power plant on a grid or localized solar energy or other renewable energy source. Such secondary battery can be used as the energy source for not only electronic devices such as a mobile phone, a laptop or tablet computer and a camcorder, but also for automobiles and power generation storage.

Depending on commercial applications, in order to implement a large output or high capacity secondary battery, a number of unit battery cells are arranged in series or in parallel. Also, based on need, a secondary battery can be augmented with a controller that controls charge or discharge of the secondary battery and prevents overcharge or overdischarge of the secondary battery.

### SUMMARY OF CERTAIN INVENTIVE ASPECTS

One inventive aspect relates to a battery pack including a secondary battery.

Another aspect is a battery pack including a secondary battery including at least a pair of electrode tabs, a circuit board where at least one device in a circuit controlling at least one of charge and discharge of the secondary battery is mounted and an insulating plate supporting the circuit board, wherein the circuit board includes a bending portion and first and second portions respectively extending from both ends of the bending portion and overlapping and spaced apart from each other, wherein the first portion includes a tab fixing surface for fixing the at least a pair of electrode tabs, wherein the second portion includes a device fixing surface where at least one device is mounted, wherein the tab fixing surface is arranged to face the second portion, wherein the insulating plate is disposed between the tab fixing surface and the second portion and closely contacts the at least a pair of electrode tabs.

The insulating plate may be harder than the circuit board.

The circuit board may be a flexible circuit board.

The device fixing surface may face an outside of the circuit board.

The battery pack may further include a pair of tab coupling terminals at the tab fixing surface, the at least a pair of electrode tabs being connected to the pair of tab coupling terminals, respectively.

The at least a pair of electrode tabs may extend along the first portion, extending towards an outer side of a secondary battery on an opposing surface of the tab fixing surface and extending towards the secondary battery on the tab fixing surface.

The bending portion may be convexly bent towards the secondary battery.

The insulating plate may be fixed to the second portion, being fixed on an opposing surface of the device fixing surface.

An area of the insulating plate may be the same as or greater than an area occupied by the at least one device on the device fixing surface and smaller than or the same as an area of the device fixing surface.

An area of the insulating plate may be the same as or greater than an area occupied by the at least a pair of electrode tabs spaced apart from each other and smaller than or the same as an area of the tab fixing surface.

The secondary battery may include a terrace portion from where the pair of electrode tabs are projected, wherein the circuit board is mounted at the terrace portion, the first portion facing the terrace portion.

The battery pack may further include an insulating tape disposed between the insulating plate and the at least a pair of electrode tabs and attached to the at least a pair of electrode tabs.

Another aspect is a battery pack comprising: a secondary battery including at least a pair of electrode tabs; a circuit board accommodating at least one circuit configured to control at least one of charging and discharging operations of the secondary battery, the circuit board including: a bending portion including first and second ends opposing each other, and first and second portions respectively extending from the first and second ends of the bending portion and at least partially overlapping and spaced apart from each other, wherein the bending portion is bent with respect to at least one of the first and second portions, wherein the first portion includes a tab fixing surface configured to fix the electrode tabs thereto, wherein the second portion includes a circuit fixing surface configured to fix the circuit thereto, and wherein the tab fixing surface faces the second portion; and an insulating plate supporting the circuit board, wherein the insulating plate is placed between the tab fixing surface and the second portion, and contacts the electrode tabs.

In the above battery pack, the insulating plate is harder than the circuit board. In the above battery pack, the circuit board is flexible. In the above battery pack, the circuit fixing surface faces an outer side of the circuit board. The above battery pack further comprises a pair of tab coupling terminals placed at the tab fixing surface, wherein the electrode tabs are connected to the tab coupling terminals, respectively. In the above battery pack, the electrode tabs extend along the first portion, extend towards an outer side of the secondary battery at an opposing surface of the tab fixing surface and extend towards the secondary battery at the tab fixing surface. In the above battery pack, the bending portion is convexly bent towards the secondary battery. In the above battery pack, the insulating plate is fixed on an opposing surface of the circuit fixing surface of the second portion.

In the above battery pack, the area of the insulating plate is substantially the same as or greater than the area occupied by the circuit on the circuit fixing surface and smaller than or substantially the same as the area of the circuit fixing surface. In the above battery pack, the area of the insulating plate is substantially the same as or greater than the area occupied by the electrode tabs spaced apart from each other and smaller than or substantially the same as the area of the tab fixing surface. In the above battery pack, the secondary battery includes a terrace portion from which the electrode tabs outwardly extend, wherein the circuit board is mounted at the terrace portion, the first portion facing the terrace portion. The above battery pack further comprises a first insulating tape placed between the insulating plate and the electrode tabs and attached to the electrode tabs.

In the above battery pack, the second portion comprises at least one wire coupling terminal connected to at least one wire configured to be electrically connected to an external device. In the above battery pack, the insulating plate overlaps the circuit in the depth dimension of the secondary battery. The above battery pack further comprises a second insulating tape covering the circuit fixing surface of the second portion, the opposing surface of the tab fixing surface and the bending portion.

Another aspect is a battery pack comprising: a secondary battery including at least one electrode tab; a circuit board accommodating thereon at least one circuit configured to control at least one of charging and discharging operations of the secondary battery; and an insulating member supporting the circuit board, wherein circuit board comprises: an intermediate portion including opposing ends; and upper and lower portions each including first and second ends opposing each other, wherein the upper and lower portions are connected to each other via the opposing ends of the intermediate portion such that the remaining upper and lower portions excluding the connected portions are spaced apart from each other, wherein the upper and lower portions and the intermediate portion surround at least three surfaces of the insulation member, wherein the upper and lower portions at least partially overlap each other in the depth dimension of the secondary battery, wherein the circuit is placed on the upper portion of the circuit board, wherein the upper portion is configured to fix the electrode tab thereto, and wherein the lower portion is configured to fix the circuit thereto.

The above battery pack further comprises at least one tab coupling terminal interposed between the insulating member and the upper portion of the circuit board. In the above battery pack, the lower portion comprises at least one wire coupling terminal connected to at least one wire configured to be electrically connected to an external device. The above battery pack further comprises a first insulating tape placed between the insulating member and the electrode tab. The above battery pack further comprises a second insulating tape covering at least partially each of the upper and lower portions and the intermediate portion.

### BRIEF DESCRIPTION OF THE DRAWINGS

FIG. 1 is a perspective view of a battery pack according to an embodiment.

FIG. 2 is an exploded perspective view of the battery pack shown in FIG. 1.

FIG. 3 is a cross-sectional view of the battery pack seen in the I-I′ direction of FIG. 1.

FIG. 4 is a perspective view of a tab fixing surface facing upwards in a state before a circuit board is folded in the battery pack shown in FIG. 1.

FIG. 5 is a perspective view of the battery pack illustrating, in the circuit board shown in FIG. 4, a device fixing surface facing upwards.

FIG. 6 is a perspective view of a secondary battery of the battery pack of FIG. 1 according to an embodiment.

FIG. 7 is an exploded perspective view of the secondary battery of FIG. 6.

FIG. 8 is a perspective view of the battery pack of FIG. 1 where the secondary battery is fixed to the circuit board in FIG. 4.

FIG. 9 is a perspective view of the battery pack of FIG. 1 where a circuit board connected to the secondary battery in FIG. 8 is folded.

FIG. 10 is a perspective view of the battery pack of FIG. 1 where a pair of electrode tabs are folded in a direction of the number 2 arrow shown in FIG. 9.

### DETAILED DESCRIPTION OF CERTAIN INVENTIVE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

In the following detailed description, only certain exemplary embodiments have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, it will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In this disclosure, the term “substantially” includes the meanings of completely, almost completely or to any significant degree under some applications and in accordance with those skilled in the art. Moreover, “formed on” can also mean “formed over.” The term “connected” includes an electrical connection.

The secondary battery described herein may be any type of battery which may be charged and discharged multiple times.

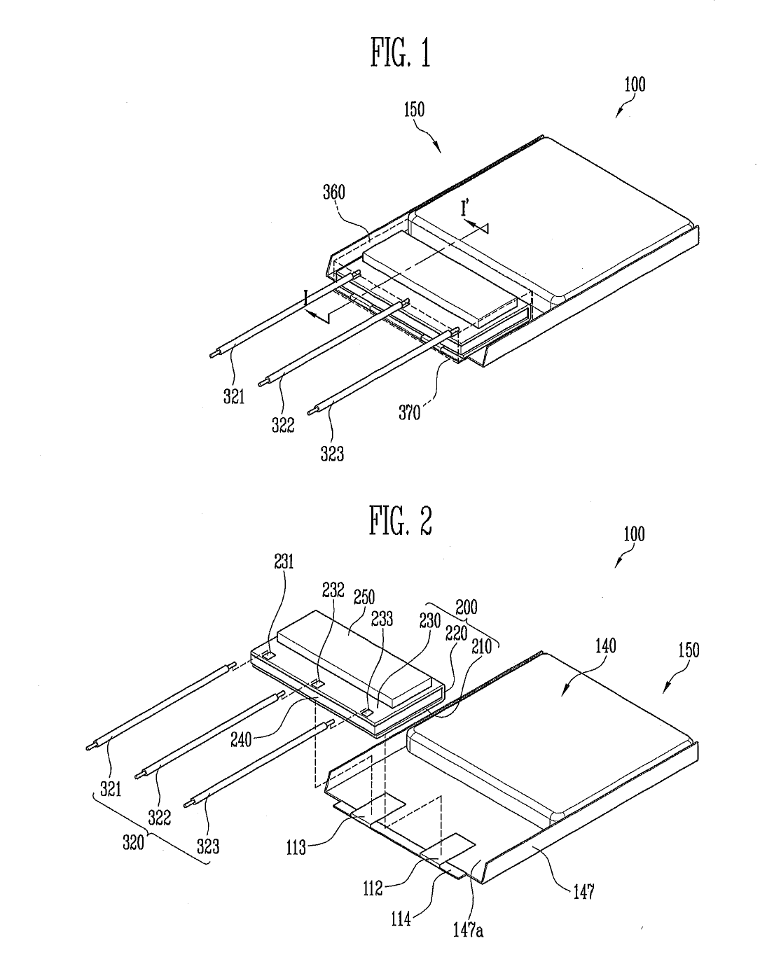

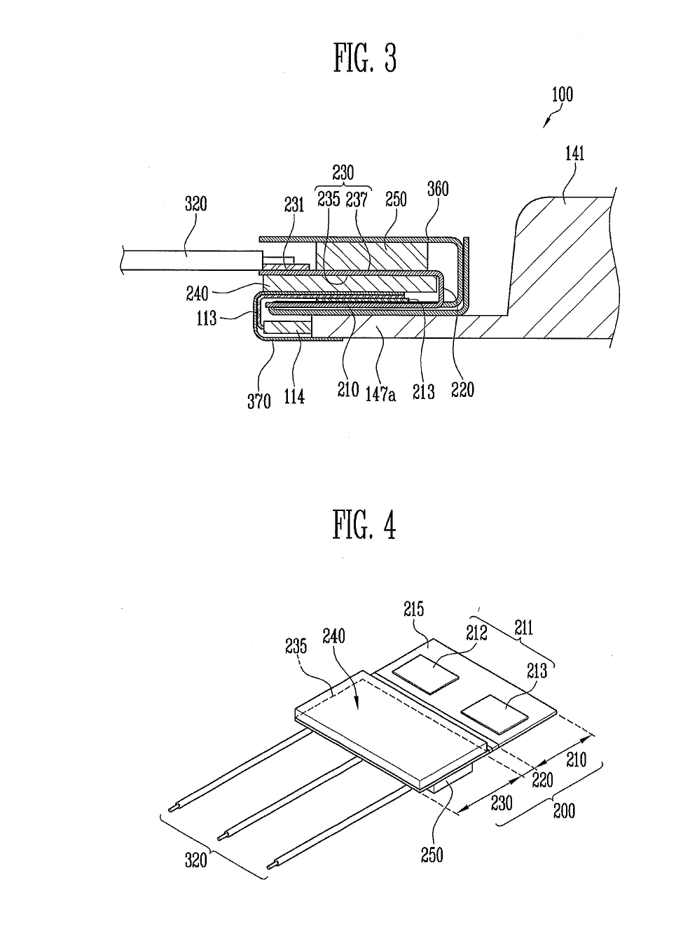

Referring to FIGS. 1 and 2, a battery pack 100 includes i) a secondary battery 150 that includes a pair of electrode tabs, ii) a circuit board 200 electrically connected to the secondary battery 150 and where a device, and the like, are mounted, iii) an insulating plate (or insulating member) 240 and iv) a plurality of insulating tapes 360 and 370.

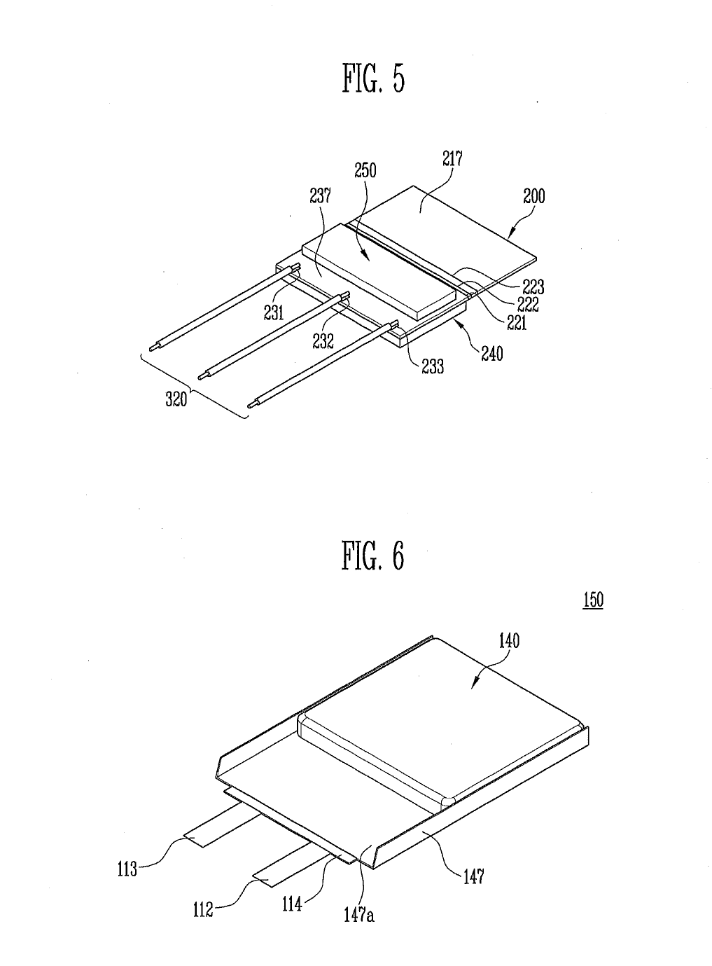

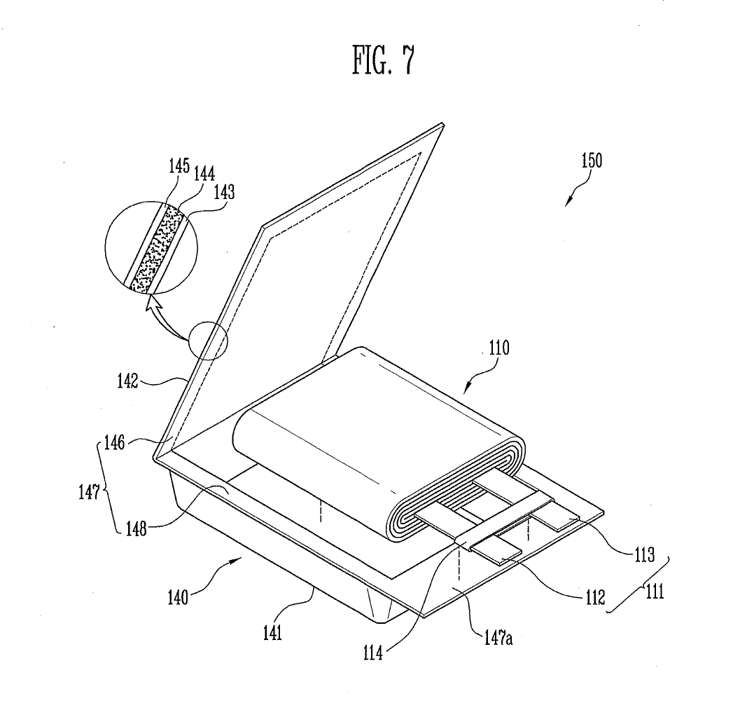

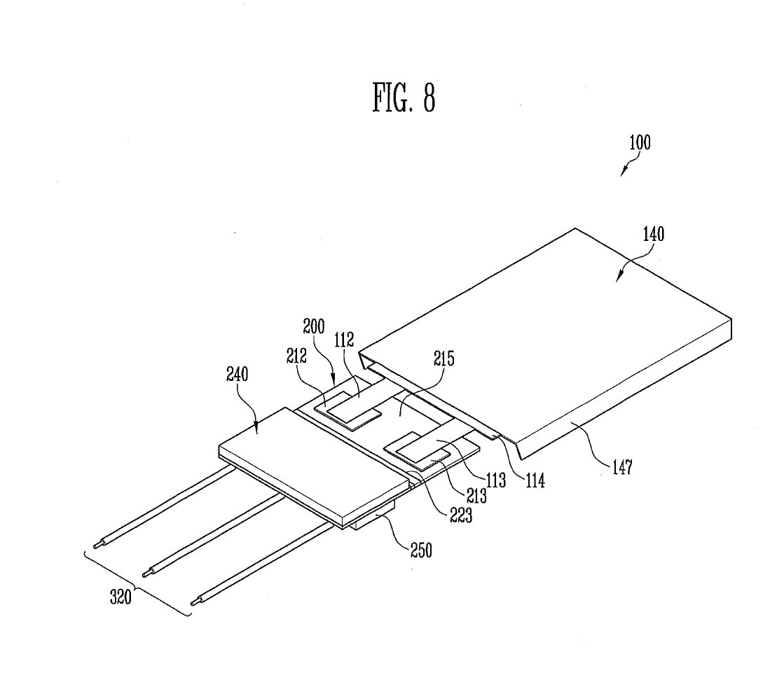

The secondary battery 150 may include an electrode assembly with a separator interposed between a pair of electrodes and an electrolyte, the electrode assembly and the electrolyte being sealed in a battery case. The pair of electrodes may have different polarities, one of them being an anode and the other being an anode. The electrode assembly may be formed by the anode, the separator and the cathode being stacked (stack type) or by being winded after being stacked (wind type). The structure of the secondary battery 150 will be described below with reference to FIGS. 6 and 7.

The secondary battery 150 may include a pair of electrode tabs 111 that extend beyond a battery case 140. The pair of electrode tabs 111 may be connected to a pair of electrodes, respectively, including an anode tab 112 connected to an anode and a cathode tab 113 connected to a cathode.

The anode tab 112 and the cathode tab 113 may outwardly extend via a terrace portion 147a of the secondary battery. The terrace portion 147a may be a part of a sealing portion 147 along a boundary of the battery case 140 which may be formed sufficiently wide to accommodate the circuit board 200, but is not limited thereto. Hereinafter, a portion where the pair of electrode tabs are projected out the sealing portion 147 of the battery case 140 may be referred to as the terrace portion 147a.

The anode tab 112 and the cathode tab 113 may extend to outside of the secondary battery 150 via the terrace portion 147a and extend towards the secondary battery 150 by being folded about 180 degrees. A detailed coupling relationship between the anode tab 112 and the cathode tab 113 and the circuit board 200 will be described below.

The circuit board 200 may be electrically connected to the secondary battery 150. At least one device 250 may be mounted thereon. Referring to FIGS. 2 to 3, the circuit board 200 may include a bending portion (or intermediate portion) 220 and first and second portions or first and second substrate portions (or upper and lower portions) 210 and 230. The first and second portions 210 and 230 extend from both ends of the bending portion 220, respectively. The first and second portions 210 and 230 are spaced apart from, while overlapping, each other.

For the purpose of convenience, the circuit board 200 before being connected to the secondary battery 150 is illustrated in FIGS. 4 and 5. FIG. 4 shows a state of the circuit board 200 before being bent. FIG. 4 is a perspective view illustrating the tab fixing surface on the top. FIG. 5 is a perspective view illustrating the device fixing surface of the circuit board 200 shown in FIG. 4 on the top. Referring to FIGS. 1 to 5, the circuit board 200 and the components installed on the circuit board 200 will be described in detail below.

The circuit board 200 may be a circuit board that has a smaller width than a length in a width direction (hereinafter, the width direction refers to a direction that is substantially perpendicular to I-I line shown in FIG. 1) of the terrace portion 147a, that extends in a length direction (hereinafter, the length direction refers to a direction that is substantially parallel to the I-I line in FIG. 1), extending as it is bent once. The bent portion of the circuit board 200 is referred to as a bending portion 220.

The circuit board 200 may include the first portion 210 where the pair of electrode tabs 112 and 113 are fixed and the second portion 230 where the at least one device 250 is fixed, the first and second portions 210 and 230 being connected by the bending portion 220.

The first portion 210 may include a substantially plate shaped member having a predetermined thickness. The first portion 210 may include a tab fixing surface 215 which is a surface where the pair of electrode tabs 112 and 113 are fixed and an opposing surface 217 of the tab fixing surface 215. There may be provided a pair of tab coupling terminals 211 on the tab fixing surface 215. The pair of tab coupling terminals 211 may include an anode tab coupling terminal 212 where the anode tab 112 is welded and a cathode tab coupling terminal 213 where the cathode tab 113 is welded. The pair of tab coupling terminals 211 may be a conductive pad.

The second portion 230 may include a substantially plate shaped member having substantially the same thickness as the first portion, a device fixing surface (or circuit fixing surface) 237 where the at least one device 250 is fixed and an opposing surface 235 of the device fixing surface 237. There may be provided a plurality of wire coupling terminals 231, 232 and 233 on the device fixing surface 237. The wire coupling terminals 231, 232 and 233 may be a plurality of conductive pads.

The wire coupling terminals 231, 232 and 233 may be arranged in an area that remains after the device 250 is mounted at the device fixing surface 237. In the drawings, it is illustrated as being provided on the boundary of the device fixing surface 237 but it is not limited thereto. If the device 250 includes a plurality of devices and is arranged by being spaced apart from each other in the width direction, the wire coupling terminals 231-233 may be arranged in empty spaces between the devices.

The bending portion 220 may be a portion formed by the circuit board 200 being folded about 180 degrees. The bending portion 220 may be a boundary that differentiates the first portion 210 and the second portion 230. Referring to FIG. 3, the bending portion 220 may be a curved surface, substantially U-shaped, a cross section in the length direction being convexly arranged towards the secondary battery 150. However, the shape of the bending portion 220 is not limited to the curved surface but may be folded about 180 degrees, forming one or two angled corners.

The circuit board 200 may be a flexible insulating substrate where conductive wires are laminated on both surfaces such that components may be mounted on the both surfaces of the circuit board 200. The circuit board 200 may be a conventional flexible printed circuit board.

An aspect of the structure described above may dispose a device compactly in a smaller space since the circuit board 200 where a device, etc. is mounted is bent. Therefore, miniaturization and compactification may be possible.

The insulating plate 240 may be disposed between the first portion 210 and the second portion 230 and insulate the first and second portions from each other 210 and 230. The insulating plate 240 may generally support the circuit board 200. The insulating plate 240 may be disposed between the tab fixing surface 215 of the first portion 210 and the second portion 230 and may apply pressure such that the pair of electrode tabs 111 may closely contact the pair of tab coupling terminals 211.

The insulating plate 240 may be a substantially plate shaped member formed of materials harder than the circuit board 200. The insulating plate 240 may have a thickness such that it is not bent. The insulating plate 240 may be a board generally having a rectangular shape as shown. However, the shape is not limited thereto, and may be of any shape which is capable of closely contacting the pair of electrode tabs to the pair of coupling terminals.

The insulating plate 240 may have a length in the width direction that is substantially the same as a length of the circuit board 200 in the width direction. However, it is not limited thereto. The insulating plate 240 may have a length in the width direction that is substantially the same as or greater than a length in the width direction of an area where the at least one device 250 is mounted in the device fixing surface 237 and smaller than a length of the circuit board 200 in the width direction. Or the insulating plate 240 may have a length in the width direction that is greater than a distance between the anode tab 112 and the cathode tab 113 and smaller than a distance of the circuit board 200 in the width direction.

The insulating plate 240 may extend as substantially the same as the distance of the second portion 230 in the length direction. However, it is not limited thereto, and the insulating plate 240 may extend in the length direction substantially the same as or greater than the length of the area where the at least one device 250 is mounted and smaller than the length of the second portion 230.

The insulating plate 240 may be formed to have a size that can support the at least one device 250 and closely contacting the one pair of electrode tabs 111 to the pair of tab coupling terminals 211.

The insulating plate 240 may be fixed on the opposing surface 235 of the device fixing surface 237, support the circuit board 200 and apply pressure on the pair of electrode tabs 111 towards the pair of tab coupling terminals 211. The insulating plate 240 may be fixed on the opposing surface 235 of the device fixing surface 237 with an adhesive.

According to the above-described aspect, the device fixing surface 237 may be firmly supported by the insulating plate 240. Also, according to the above-described aspect, since the insulating plate 240 is provided between the first portion 210 and the second portion 230 overlapping each other, the circuit board 200 that is bent may be firmly supported, and the pair of electrode tabs 111 may be firmly fixed to the circuit board.

A plurality of wires 321, 322 and 323 may each be welded to the of wire coupling terminals 231, 232 and 233, respectively, electrically coupling the battery pack to an external device (now shown) to supply power from the battery pack to the external device or to supply power from the external device to the battery pack, via the wires 320. As a result, the at least one device 250 may operate, or the secondary battery 150 may be charged. The at least one device 250 may operate as it receives power supplied from the secondary battery 150. The wires 320 may be, unlike as shown in the drawings, of a harness type.

The at least one device 250 may be electrically connected to the secondary battery 150 via the circuit board 200, implementing a circuit that performs at least one control functions which are predetermined. The control function may include control relating to management of battery such as charge control, discharge control, overcharge control, overdischarge prevention control, other safety related control, sensor control, and communication control with an external device, for the secondary battery. The sensor may include temperature sensor, voltage sensor, current sensor and the like. Data for performing safely control can be collected via the sensor, for example temperature of a battery and the like can be measured by the temperature sensor.

In an embodiment of a circuit that performs control functions, the at least one device 250 may be at least a part of a protective circuit of the secondary battery 150. The protective circuit refers to a circuit capable of protecting a battery not only by controlling charge and discharge by controlling voltage or current of the secondary battery 150 but also by blocking overcharge, overdischarge, short circuit, inverse voltage and the like.

For example but without limitation thereto, in order to make up the protective circuit, the at least one device 250 may include at least one of a field effect transistor, an integrated circuit, a positive temperature coefficient, a switching device and the like, thereby controlling charge and discharge and blocking circuit.

The circuit board 200 with the at least one device 250, the wires 320 and the pair of tab coupling terminals 211 may be a control module. The control module may be electrically connected to the secondary battery to perform control relating to management of the secondary battery 150. Hereinafter, the control module may refer to a module including the circuit board 200, at least one device (or at least one circuit) 250 mounted on the circuit board, the wires 320 and the insulating plate 240, and the pair of tab coupling terminals 211 being connected to the circuit board.

Referring to FIGS. 2 and 3, the first portion 210 and the second portion 230 may overlap each other as they are spaced apart from each other. The first portion 210 may be arranged such that the tab fixing surface 215 faces the second portion 230. The second portion 230 may be arranged such that the opposing surface 235 of the device fixing surface 237 face the tab fixing surface 215. On the opposing surface 235 of the device fixing surface 237, the insulating plate 240 may be fixed, such that the tab fixing surface 215 of the first portion 210 may face the insulating plate 240.

The pair of electrode tabs 111 may outwardly extend from the terrace portion 147a. The pair of electrode tabs 111 may extend along the first portion 210, extending to an outer side of the secondary battery 150 on the opposing surface 217 of the tab fixing surface 215, bending in an opposite direction, and extending towards the secondary battery 150 on the tab fixing surface 215. The pair of electrode tabs 111 may be fixed to the pair of tab coupling terminals 211, respectively, on the tab fixing surface 215. The electrode tabs 112 and 113 may be respectively fixed to the tab coupling terminals 211 by forming a welding portion by laser welding and the like.

A first insulating tape 370 may be adhered to the pair of electrode tabs 111, thereby insulating the electrode tabs 111 from a periphery. The first insulting tape 370 may be attached to cover all of the pair of electrode tabs 111 between the insulating plate 240 and the pair of electrode tabs 111. The pair of electrode tabs 111 may pass the bent area and extend to the terrace portion 147a.

A second insulating tape 360 may be further attached to the circuit board 200, insulating the circuit board 200 and the components mounted on the board from the periphery. The second insulating tape 360 may be attached to cover the substantial entirety of the device fixing surface 237 of the second portion, the opposing surface 217 of the tab fixing surface 215 and the bending portion 220 therebetween.

FIGS. 6 and 7 illustrate a secondary battery, including an electrode assembly that is sealed in a pouch type case according to some embodiments. The secondary battery 150 may include a battery case 140 and an electrode assembly 110 that is sealed together with an electrolyte in the battery case.

Referring to FIG. 7, the electrode assembly 110 may be formed by stacking an anode plate, a separating plate and a cathode plate sequentially, and thereafter winding them. The anode plate may function as an anode, and the cathode plate may function as a cathode. The electrode assembly 110 may include a pair of electrode tabs 111 that extend to outside of the battery case. The pair of electrode tabs 111 may include an anode tab 112 that is electrically connected to the anode and a cathode tab 113 that is electrically connected to the cathode plate. However, the anode tab 112 and the cathode tab 113 may be switched in terms of position. Electrochemical energy generated by the secondary battery may be transferred to outside by the pair of electrode tabs 111.

The battery case 140 may be a member that surrounds the electrode assembly 110. The battery case 140 may include a first portion case 141 and a second portion case 142. A space for receiving the electrode assembly 110 may be formed in the first portion case 141. The second portion case 142 may cover the first portion case 141. The space for receiving the electrode assembly 110 may correspond to a shape and a size of the electrode assembly 110. For example, but without limitation thereto, the space for receiving the electrode assembly 110 may be made by a deep drawing process which is used for manufacturing a seamless hollow container on a flat board.

The secondary battery 150 may be manufactured by providing the electrode assembly 110 and the electrolyte in the space for receiving the electrode assembly 110 and by forming a sealing portion 147 by thermal bonding edges 148 of the first portion case 141 and edges 146 of the second portion case 142 in a state where the first portion case 141 and the second portion case 142 are in close contact with each other. The electrode tabs 111 of the electrode assembly 110 may extend to outside of the battery case through the sealing portion 147.

Referring to FIG. 7, the battery case 140 may include an inner resin layer 143, a metal layer 144 and an outer resin layer 145, sequentially. The inner resin layer 143 may directly face the electrode assembly 110. The outer resin layer 145 may correspond to an outermost surface of the battery case 140. The inner resin layer 143 and the outer resin layer 145 may be formed of a polymer resin, etc., which is an electrically non-conductor, in order to prevent short circuit and the like. The metal layer 144 may be provided between the inner resin layer 143 and the outer resin layer 145. The metal layer 144 may provide a predetermined mechanical strength to the battery case 140, and may include, for example but without limitation thereto, aluminum and the like.

The pair of electrode tabs 111 may further include a film 114 for insulation. The film 114 may insulate between the pair of electrode tabs 111 and the battery case 140. The film 114 may be safely mounted at the sealing portion 147. The film 114 may be made of an electrically non-conductor and prevent short circuit of the pair of electrode tabs 111 and the metal layer 144. The film 144 may be made of a similar material as the sealing portion 147. As a result, the sealing portion 147 may be thermally bonded completely. The electrode tabs 111 formed of a metal by the film may closely contact the sealing portion 147 completely, strengthening sealing force of the battery case 140. The film 114 may be bent along the curved surface of the electrode tabs 111.

It has been described in detail that the electrode assembly of winding type is sealed in a pouch type case as the secondary battery 150 with reference to FIGS. 6 and 7. However, the present invention is not limited thereto. A stack type electrode assembly may be sealed in a pouch type case or a stack or winding type electrode assembly may be sealed in an angular case.

Though not illustrated, a battery pack in FIG. 1 may further include a third insulating tape that overall surrounds a control module and the terrace portion 147a where the control module is mounted but such that the plurality of wires 320 are exposed. The battery pack as shown in FIG. 1 may further include a label attached to an outer surface of the battery case 140.

Hereinafter, a manufacturing method of the battery pack according to one embodiment is described with reference to FIGS. 1 to 10. Referring to FIG. 8, the anode tab 112 and the cathode tab 113 may be connected to the pair of tab coupling terminals 212 and 213, respectively, of the control module. The anode tab 112 and the cathode tab 113 may be fixed to the tab coupling terminals by welding.

As shown in FIG. 8, a first insulating tape 370 may be attached to a pair of electrode tabs 112 and 113 connected to the control module. Though not illustrated, the first insulating tape 370 may be attached to cover not only the pair of electrode tabs 111 but also the tab fixing surface 215, the film 114 and the terrace portion 147a, partially or completely.

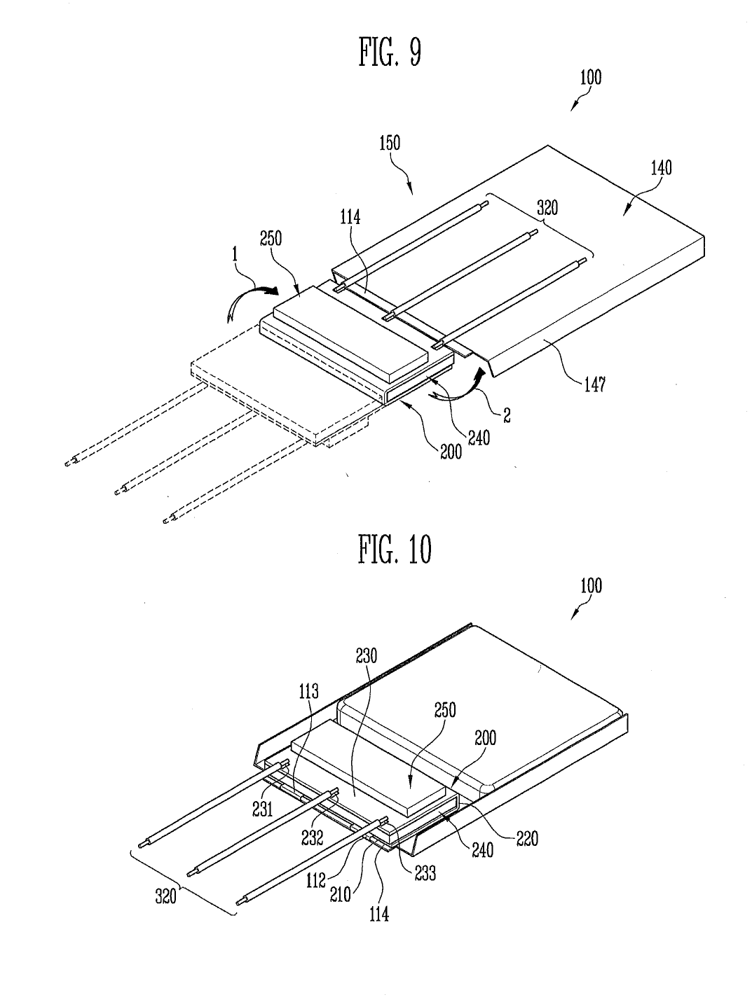

The control module where the first insulating tape 370 is attached to the pair of electrode tabs 111 and the periphery may be folded almost 180 degrees in a direction of arrow 1 shown in FIG. 9 along a plurality of guide lines 221, 222 and 223 shown in FIG. 5. The circuit board 200 folded in the direction of arrow 1 in FIG. 9 may include a bending portion 220.

A second insulating tape 360 may be attached to the control module that is folded in the direction of arrow 1 in FIG. 9. Though not illustrated, the second insulating tape 360 may be attached to cover the substantial entirety of the device fixing surface 237, a bending portion 220 of the same surface as the device fixing surface 237 and the opposing surface 215 of the tab fixing surface 215. The second insulating tape 360 may cover the substantial entirety of the device fixing surface 237, the opposing surface 217 of the tab fixing surface 215 and the bending portion 220 therebetween in the circuit board 200 shown in FIG. 5. However, the first and second insulating tapes 370 and 360 being attached as such is omitted from FIGS. 8 to 10.

The control module where both of the first insulating tape 370 and the second insulating tape 360 are attached may be mounted at the terrace portion 147a as shown in FIG. 10 by a pair of electrode tabs 111 being folded in a direction of arrow 2 in FIG. 9. The opposing surface 217 of the tab fixing surface may be mounted to face the terrace portion 147a and may be the battery pack as shown in FIG. 3.

Though not illustrated, a third insulating tape may be further attached to the battery pack in FIG. 10 to surround all of the control module and the terrace portion. A label may be further attached to the case of the secondary battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack comprising:
a secondary battery including at least a pair of electrode tabs;
a circuit board accommodating at least one circuit configured to control at least one of charging and discharging operations of the secondary battery, the circuit board including:
a bending portion including first and second ends opposing each other, and
first and second portions respectively extending from the first and second ends of the bending portion and at least partially overlapping and spaced apart from each other, wherein the bending portion is bent with respect to at least one of the first and second portions, wherein the first portion includes a tab fixing surface configured to fix the electrode tabs thereto, wherein the second portion includes a circuit fixing surface configured to fix the circuit thereto, and wherein the tab fixing surface faces the second portion; and
an insulating plate supporting the circuit board, wherein the insulating plate is placed between the tab fixing surface and the second portion, and contacts the electrode tabs.

2. The battery pack as claimed in claim 1, wherein the insulating plate is harder than the circuit board.

3. The battery pack as claimed in claim 1, wherein the circuit board is flexible.

4. The battery pack as claimed in claim 1, wherein the circuit fixing surface faces an outer side of the circuit board.

5. The battery pack as claimed in claim 1, further comprising a pair of tab coupling terminals placed at the tab fixing surface, wherein the electrode tabs are connected to the tab coupling terminals, respectively.

6. The battery pack as claimed in claim 1, wherein the electrode tabs extend along the first portion, extend towards an outer side of the secondary battery at an opposing surface of the tab fixing surface and extend towards the secondary battery at the tab fixing surface.

7. The battery pack as claimed in claim 1, wherein the bending portion is convexly bent towards the secondary battery.

8. The battery pack as claimed in claim 1, wherein the insulating plate is fixed on an opposing surface of the circuit fixing surface of the second portion.

9. The battery pack as claimed in claim 1, wherein the area of the insulating plate is substantially the same as or greater than the area occupied by the circuit on the circuit fixing surface and smaller than or substantially the same as the area of the circuit fixing surface.

10. The battery pack as claimed in claim 1, wherein the area of the insulating plate is substantially the same as or greater than the area occupied by the electrode tabs spaced apart from each other and smaller than or substantially the same as the area of the tab fixing surface.

11. The battery pack as claimed in claim 1, wherein the secondary battery includes a terrace portion from which the electrode tabs outwardly extend,
wherein the circuit board is mounted at the terrace portion, the first portion facing the terrace portion.

12. The battery pack as claimed in claim 1, further comprising a first insulating tape placed between the insulating plate and the electrode tabs and attached to the electrode tabs.

13. The battery pack as claimed in claim 1, wherein the second portion comprises at least one wire coupling terminal connected to at least one wire configured to be electrically connected to an external device.

14. The battery pack as claimed in claim 1, wherein the insulating plate overlaps the circuit in the depth dimension of the secondary battery.

15. The battery pack as claimed in claim 1, further comprising a second insulating tape covering the circuit fixing surface of the second portion, the opposing surface of the tab fixing surface and the bending portion.

16. A battery pack comprising:
a secondary battery including at least one electrode tab;
a circuit board accommodating thereon at least one circuit configured to control at least one of charging and discharging operations of the secondary battery; and
an insulating member supporting the circuit board,
wherein circuit board comprises:
an intermediate portion including opposing ends; and
upper and lower portions each including first and second ends opposing each other, wherein the upper and lower portions are connected to each other via the opposing ends of the intermediate portion such that the remaining upper and lower portions excluding the connected portions are spaced apart from each other, wherein the upper and lower portions and the intermediate portion surround at least three surfaces of the insulation member, wherein the upper and lower portions at least partially overlap each other in the depth dimension of the secondary battery, wherein the circuit is placed on the upper portion of the circuit board, wherein the upper portion is configured to fix the electrode tab thereto, and wherein the lower portion is configured to fix the circuit thereto.

17. The battery pack as claimed in claim 16, further comprising at least one tab coupling terminal interposed between the insulating member and the upper portion of the circuit board.

18. The battery pack as claimed in claim 16, wherein the lower portion comprises at least one wire coupling terminal connected to at least one wire configured to be electrically connected to an external device.

19. The battery pack as claimed in claim 16, further comprising a first insulating tape placed between the insulating member and the electrode tab.

20. The battery pack as claimed in claim 16, further comprising a second insulating tape covering at least partially each of the upper and lower portions and the intermediate portion.
